(19) United States
(12) Patent Application Publication
(10) Pub. No.: US 2010/0178388 A1
(43) Pub. Date: Jul. 15, 2010

(54) BAKE-STABLE FOOD FILLING AND METHODS RELATED THERETO

(76) Inventor: Bin Fu, Battle Creek, MI (US)

Correspondence Address: Randall L. Shoemaker;Dickinson Wright PLLC, Ste. 2000, 38525 Woodward Ave., Bloomfield Hills, MI, 48304-2970, US

(21) Appl. No.: 12/683,630

(22) Filed: Jan. 7, 2010

Related U.S. Application Data
(60) Provisional application No. 61/143,507, filed on Jan. 9, 2009.

(51) Int. Cl. A23L 1/308; A21D 13/08

(52) U.S. Cl. 426/62; 426/573; 426/582; 426/583; 426/94

(57) ABSTRACT

A fluffy, bake-stable filling is applied to a dough component and baked to provide a food product having a crispy exterior and a creamy interior. The bake-stable filling is formed by mixing fat ingredients, such as soybean oil, and a fiber ingredients, such as oat fiber. Next, the method includes mixing more of the fiber ingredients and optional ingredients, such as cheese powder, whey protein powder, salt, yeast enhancer, and paprika. The bake-stable filling has a baked density of less than 1.875 g/cm³ and a baked water activity level of less than 0.35. The fiber ingredients have a particle size of less than about 150 μm. The fat ingredients of the filling substantially refrain from spreading to the dough component during or after baking so that the dough component remains crispy.

### RELATED APPLICATIONS

This application claims the benefit of U.S. provisional application Ser. No. 61/143,507 filed Jan. 9, 2009.

### STATEMENT REGARDING FEDERALLY SPONSORED RESEARCH

None.

### FIELD OF THE INVENTION

This invention relates generally to filled food products and, more particularly, to bake-stable food fillings, methods to make and use the bake-stable food fillings, and unbaked or baked fillings having creamy and airy attributes.

### BACKGROUND OF THE INVENTION

Fluffy, creamy, bake-stable food fillings are a particular challenge for food processors. Creamy unbaked fillings can be fat-based, whereas creamy baked fillings must account for the very reason that fats impart a creamy feeling on the palate: they melt easily. Even low levels of melt result in a collapsed structure to an otherwise stabilized filling, creating density and texture problems. It is therefore particularly difficult to create a fluffy and creamy filling that is also stable when baked.

With regard to previous bake-stable fillings, a common approach is to add humectants, small proteins, emulsifiers, starches, polyols, and/or gums to stabilize fats. As a result, these stabilizers sometimes work too well, thereby creating an undesirably dense and/or gummy mouth feel and/or bitter-sweet taste.

Moreover, developers encounter problems controlling moisture transfer from the filling to that part of the food which is being filled; often, a dough crust. When water activity is not controlled, moisture from the filling migrates to the baked exterior, eventually equilibrating and making the exterior soft or even soggy. It is for the above reasons that food products with a crisp exterior and a creamy interior are often filled post-bake, either because the filling will melt or because moisture transfer will cause a soggy exterior.

### SUMMARY OF THE INVENTION

The invention provides a bake-stable filling for food products comprising at least one fat ingredient and at least one fiber ingredient. The bake-stable filling has an unbaked density and a baked density. The baked density is less than about 1.875 grams per cubic centimeter (g/cm³) and is no greater than about 125 percent (%) of the unbaked density. The bake-stable filling also has a baked water activity level of less than about 0.35. The invention also provides a food product including the bake-stable filling applied to a dough component.

The invention further provides a process of forming the bake-stable filling comprising the steps of mixing at least one fiber ingredient and at least one fat ingredient at a first speed to form a first blend; mixing the first blend and at least one fiber ingredient at a second speed greater than the first speed to form a second blend; and mixing the second blend until the second blend has a baked density of less than about 1.875 g/cm³ and a baked water activity level of less than about 0.35.

Although the bake-stable filling can be used in unbaked foods, the bake-stable filling is typically applied to or injected into the dough component and baked to provide the food product having a crispy exterior and a creamy interior. One advantage is that the bake-stable filling can be applied to the dough component before baking. The bake-stable filling does not melt, and moisture does not transfer from the bake-stable filling to the dough component during or after baking. Therefore, the dough component remains crispy. The food product maintains the crispy exterior and creamy interior, even after months held at room temperature under commercial conditions.

Further, the bake-stable filling can provide a significant amount of dietary fiber. Health advocates have long promoted the need for consumers to increase their intake of dietary fiber, and consumers are motivated by this perceived health benefit when choosing snacks. In addition to providing a significant amount of fiber, the bake-stable filling has a desirable taste and a fluffy, creamy, and desirable texture. Finally, the process of forming the bake-stable filling can be performed with minimal disruption of existing food manufacturing processes.

### DEFINITIONS

“Bake-stable” means spreading or flow is minimal when dry heat is applied.

“Baked density” means density after applying dry heat.

“Baked water activity level” means water activity level after applying dry heat.

“Fiber” means any food ingredient fiber as that term is known to those of ordinary skill in the art, and includes soluble and insoluble fibers. In this application, “fiber” means food ingredient fibers having been purified/condensed/isolated compared to the natural state, whether 100% purified or any percentage up to that which is found in nature. For instance, “citrus fiber” does not include an orange, but does include orange pulp having residual juice. “Fiber” includes those from natural sources, such as from plants, as well as chemically engineered food fibers. The term fiber may also include mixtures of fibers in a variety of ratios.

“Unbaked density” means density before applying dry heat.

“Unbaked water activity level” means water activity level before applying dry heat.

### DETAILED DESCRIPTION

The present invention is directed toward a bake-stable filling that contains fat ingredients, yet retains creaminess and a relatively low density (highly aerated), even when heated. The bake-stable filling also includes fiber ingredients. Methods for producing the bake-stable filling are also provided, as are methods for using the bake-stable filling. Food products including the bake-stable filling are also provided. The bake-stable tilling is typically applied to a dough component. In specific examples, the bake-stable filling is used in snacks having a dough exterior, such as a layered cracker or filled bar, however, the bake-stable filling can be utilized in a wide variety of other foods and food forms.

Fat Ingredients. The bake-stable filling includes at least one fat ingredient, but typically several fat ingredients. The fat ingredients may be any fat, including, without limitation: any edible fat, oil, or shortening, including those that are solid at room temperature and those that are liquid at room temperature. Liquid shortenings or oils are usable and provide an advantage of ease of incorporation. Solid shortening is usable and provides an advantage of desirable mouth feel upon consumption. A mixture of liquid and solid shortenings is also acceptable. Liquid fats useful in the bake-stable filling include animal shortening, marine fat, vegetable or synthetic oil, such as sucrose polyesters, which are liquid at ordinary room temperature. The fat ingredients of the bake-stable filling may also comprise natural or hydrogenated oils, including soybean oil, cottonseed oil, canola (rapeseed) oil, peanut oil, safflower oil, sesame oil, sunflower oil, poppyseed oil, coconut oil, palm oil, palm kernel oil, olive oil, butterfat, cocoa butter, tallow, lard, babassue, corn oil, or combinations thereof.

Preferably, the fat ingredients of the bake-stable filling include a vegetable fat. More preferably, the fat ingredients comprise a vegetable fat selected from the group consisting of: soybean oil, cottonseed oil, canola oil, safflower oil, sunflower oil, coconut oil, palm oil, palm kernel oil, and corn oil. Most preferably, the fat ingredients include soybean oil.

Preferably, the bake-stable filling includes the fat ingredients in a total amount of about 20.0 weight percent (wt. %) to about 40.0 wt. % of the bake-stable filling based on the total weight of the filling. More preferably, the bake-stable filling includes the fat ingredients in a total amount of about 25.0 wt. % to about 35.0 wt. %; most preferably about 30.0 wt. % to about 33.0 wt. %.

Fiber Ingredients. The bake-stable filling includes at least one fiber ingredient, but typically several fiber ingredients. The fiber ingredients preferably include a powder-like particle size. Preferred are fiber ingredients having an average particle size of less than about 150 μm. More preferred are fiber ingredients having an average particle size of from about 10 μm to about 100 μm. Most preferred are fiber ingredients that are considered fine, superfine or microground powders.

Any fiber source is acceptable for the fiber ingredients of the bake-stable filling, including: both soluble and insoluble fiber, as well as sources generally known to contribute insoluble fiber, such as soy fiber, apple fiber, corn bran, wheat bran, wheat fiber, cocoa fiber, bamboo fiber, oat bran, barley bran, rye bran, triticale bran, cellulose, pea fiber, sugar beet fiber, and peanut fiber. Sources generally known to contribute soluble fiber include but are not limited to fructo-oligo saccharides, inulin, gum arabic, gum ghatti, guar gum, pectins, psyllium, carrageenans, xanthan, tragacanth, karaya, locust bean gum, agar, and alginates. Other useful fiber ingredients include polysaccharides, such as polydextrose and other complex sugar polymers or prebiotic fibers.

More preferred are fiber ingredients selected from the group consisting of: polydextrose; grain fiber; and indigestible dextrin (such as maltodextrin). Indeed, a combination of oat fiber with other fibers provides a more rounded mouthfeel. The most preferred fiber ingredient is oat fiber.

Preferably, the bake-stable filling includes the fiber ingredients in a total amount of about 5.0 wt. % to about 20.0 wt. % of the bake-stable filling based on the total weight of the filling. More preferably, the bake-stable filling includes the fiber ingredients in a total amount of about 7.0 wt. % to about 15.0 wt. %; most preferably 10.0 wt. % to about 12.0 wt. %.

Optional Ingredients. In order to provide bulk and flavor, optional ingredients may be employed in the bake-stable filling. For cheese or dairy flavored embodiments, milk, milk products, or milk components may be employed. The optional ingredients are ideally small in particle size. Preferred are optional ingredients having a particle size less than about 200 μm. More preferred are optional ingredients having a particle size from about 50 μm to about 150 μm. Most preferred are optional ingredients that are considered a fine, superfine or microground powders.

Many types of optional ingredients are acceptable for use in the bake-stable filling. Preferably, each of the optional ingredients are essentially a “dry powder” as that term is commonly used, and not meant to exclude powders having residual moisture or fat. The optional ingredients may include at least one protein ingredient, at least one dairy ingredient, or both protein and dairy ingredients. For example, the optional ingredients may include soybean, legume, or nut powder; dry milk powder; cheese powder; whey powder; and whey protein concentrate powder.

The optional ingredients may also include fruits; nut butter; chocolate; vanilla; flour; salt; pepper; herbs; spices; and flavorants. Flavorants can be any known in the art, including those that contribute a flavor selected from the group consisting of: meat; cheese; fruit; vegetable; spice; herb; chocolate; vanilla; or any combination thereof.

However, since cheese and dairy fillings have remained elusive to processors with regard to bake stability, a preferred utility of the bake-stable filling relates to dairy fillings. The bake-stable filling may be cheese-based, sour cream-based, such as onion dip, or yogurt-based, including fruit flavored yogurts, to name but a few, in which the optional ingredients would include at least one dairy ingredient. In Europe, quark- and goat cheese-based bake-stable fillings may be preferred. In Asia, dairy substitutes, such as fermented bean curd, may be preferred. The Most preferred optional ingredients are cheese powder; cheese filling; acid whey powder; whey protein concentrate powder; flour; salt; yeast enhancer; and paprika.

Preferably, the bake-stable filling includes the optional ingredients in a total amount of about 40.0 wt. % to about 75.0 wt. % of the bake-stable filling. More preferably, the bake-stable filling includes the optional ingredients in a total amount of about 50.0 wt. % to about 68.0 wt. %; and most preferably about 55.0 wt. % to about 60.0 wt. %.

Surprising Results. During experimentation, relationships were observed between fiber content, fiber particle size, fiber water holding capacity, and fat droplet holding capacity. In general, for the same type of fiber, the higher the fiber content, the higher the water holding capacity, and the higher the fat droplet holding capacity. In addition, at the same fiber content, as fiber particle size decreased, fiber water holding capacity increased, and fat droplet holding capacity also increased. These are novel, unexpected, and surprising relationships.

While not wishing to be bound by any one theory, the present inventor surmises that including fiber ingredients with fat ingredients according to the processes described herein creates a microstructure of fat globules in a matrix, such that when heat is applied to the bake-stable filling, the matrix withstands the pull of gravity on micro-puddles of melted fat ingredients. The melted fat ingredients are hypothesized to be trapped within the fiber ingredient fabric, such that the macrostructure does not spread, flow or otherwise “oil out.”

Density. The bake-stable filling is characterized by a potential for density (δ) change of less than 25% from unbaked to baked embodiments. In other words, the baked density is no greater than about 125 percent (%) of the unbaked density.

The preferred unbaked density of the bake-stable filling is less than about 1.5 grams per cubic centimeter (g/cm³). More preferred is an unbaked density of about 0.5 to about 1.2 g/cm³. Most preferred is an unbaked density of less than 1.0 g/cm³. Density is measured by dividing the weight of a certain volume of the bake-stable filling (minus the container weight) by the volume. The resultant units of measure may be converted to grams per cubic centimeter using known conversion charts or calculators. Density is also known as a “degree of aeration” or “cream volume.”

Water Activity. The bake-stable filling also has a limited water activity level (A_{w}) change from unbaked to baked embodiments. In other words, the relationship of an unbaked water activity level to a baked water activity level of the bake-stable filling can be described by the formula: A_{w}, unbaked≧A_{w} baked.

The preferred unbaked water activity level of the bake-stable filling is less than about 0.7. More preferred is an unbaked water activity level less than about 0.6, and most preferred is an unbaked water activity less than about 0.5.

The bake-stable filling is typically applied to the dough component to form a food product and then baked, and the baked water activity level of the bake-stable filling is measured after baking. The baked water activity level is preferably less than about 0.35, more preferably less than about 0.3, and most preferably less than about 0.25. As a result of the low baked water activity level of the bake-stable filling, little to no moisture migrates from the bake-stable filling to the dough component. The unbaked and baked water activity levels are measured by any commercially-available water activity meter.

Bake Stability. In order to measure bake stability of the filling, a spoonful of the filling is obtained and the underside of the spoon is wiped reasonably free of the filling. The spoon is then placed in a conventional microwave oven for 15 to 30 seconds. The conventional microwave oven heats the filling by passing microwave radiation through the filling at a frequency of about 2.0 GHz to about 3.0 GHz. The spoonful of filling is then immediately placed on a sample tray. If little or no spread of the filling is observed and no fat ingredient, such as free oil, drips onto the tray, the filling is bake-stable. If the fat ingredient is observed on the tray, the filling is not bake-stable.

Method of processing. The method of forming the bake-stable filling typically includes at least two steps. First, the method includes mixing the fat ingredients and about half of the fiber ingredients at a first speed to form a first blend. The first blend is mixed to uniformity. Second, the method includes mixing the first blend, optional ingredients, and the other half of the fiber ingredients at a second speed to form a second blend. The second speed is greater than the first speed. The fiber ingredients mixed in the second step may be the same as or different from the fiber ingredients of the first step. The first and second steps may include mixing a single fiber ingredient or several fibers ingredients. The second blend is vigorously blended to uniformity and until the second blend has a baked density of less than about 1.875 g/cm³ and a baked water activity level of less than about 0.35 to provide the bake-stable filling. The second blend can also be blended until the second blend has an unbaked density of less than about 1.5 g/cm³ and an unbaked water activity level of less than about 0.6 to provide the bake-stable filling.

More fiber may be added during subsequent stages of processing, such as after the second step, with the dough component, or as a topping or coating of the food product. Large quantities of optional ingredients may be introduced in the second step. Moreover, small quantities of optional ingredients may be introduced prior to, or with, the first step, for example, lecithin, flavorants, and colorants.

For either the first or second step, mixing may be accomplished via any method known in the art, preferably with a mixer such as a standard Hobart mixer or large scale mixer. For the first step, mixing is preferably accomplished at low speed, until the fat ingredients and the fiber ingredients are blended. For the second step, the mixing is preferably at high speed, until the desired density is achieved.

Baked Embodiment The bake-stable filling can be applied to the dough component to form the bake-stable food product. The bake-stable filling can be injected into the dough component, co-extruded with the dough component, disposed between sheets of the dough component, or otherwise applied to the dough component. In other words, the bake-stable filling is typically surrounded by, sandwiched by, or disposed on top of the dough component.

The bake-stable filling can be applied to the dough component before or after baking, but is typically injected into the dough component before baking. The food product is baked to provide a crispy exterior, while maintaining a creamy interior. One advantage of the bake-stable filling is that it does not melt, and moisture does not transfer from the bake-stable filling to the dough component during or after baking. Therefore, the dough component remains crispy. The food product maintains the crispy exterior and creamy interior, even after months held at room temperature under commercial conditions.

Dough components useful in the food product can be any type of dough. With regard to ease of processing, preferred are those doughs that are sheetable or extrudable, including, preferably, laminated or non-laminated cracker dough, cracker dough with some sweeteners added, cracker dough that is leavened, cracker dough that has been fermented, cracker dough with flavorings and/or cracker dough with inclusions or toppings. The dough component typically includes a flour or starch ingredient, such as yeast dough, straight dough, or sponge dough, with or without sweetness.

Examples of preferred doughs include those selected from the group consisting of: soda cracker; multi-grain cracker; high fiber cracker; high protein cracker; wheat cracker; butter cracker; cheese-flavored cracker; graham cracker; chocolate or other sweet-flavored crackers; and herbed flatbread cracker. Ideally, the dough component is sheetable or extrudable on an industrial scale, with any cracker dough being best, or an adaption of a cracker dough that does not hinder sheeting also being a preferred option.

The same type of dough can be used for the entire dough component of the food product, but combinations of doughs, for example two doughs each having a different type (color, flavor, inclusions, processing differences, etc.) can also be used. Any particular dough itself may be a hybrid of dough types as well, so as to provide any functional or aesthetic result. Moreover, soft doughs, such as bread, quick bread doughs, pastry, etc. are can also be used.

The dough component is made according to methods generally known in the art, and includes mixing flour, fat and moisture, ordinarily water, and most often, salt. Additional ingredients, such as sweeteners, flavors, inclusions, colors, nutritional supplements, leavening agents, sulfites, and dough conditioners, such as emulsifiers, reducing agents, and/or oxidizing agents may be added to the dough component as well.

The following examples are provided for further describing the scope, and for providing further description and enablement. The examples are not intended to be limiting; the invention is defined by the entirety of the specification, drawings, and claims.

### Example 1

### Cheese Bake-Stable Filling

TABLE 1

| Component | Percent by weight (wt. %) |
|---|---|
| Soybean Oil | 32.00 |
| Cheese Powder | 20.00 |
| Acid Whey | 17.50 |
| Whey Protein Concentrate | 14.00 |
| Polydextrose | 5.00 |
| Oat Fiber (super fine microground) | 4.00 |
| Oat Fiber (fine microground) | 2.50 |
| Flour Salt | 2.00 |
| Lecithin (soy) | 1.50 |
| Yeast enhancer | 1.30 |
| Paprika | 0.70 |
| Total | 100.00 |

First, all of the soybean oil, lecithin, and paprika are blended to uniformity in the bowl of a Hobart mixer. The oat fibers (both grinds) are placed in the bowl with oil/lecithin/paprika mix, and the combination is mixed to uniformity, on low speed, for several minutes. The polydextrose and remainder of the ingredients are subsequently added to the bowl and blended on high speed until achieving a density of 0.75 to 1.0 g/cm³. All mixing is done at room temperature. The bake stability is measured by microwaving a plastic spoonful, on medium setting, for 30 seconds. Little to no spread is observed, and the bake-stable filling does not overflow the spoon.

### Example 2

### Cheese Bake-Stable Filling

TABLE 2

| Component | Percent by weight |
|---|---|
| Soybean Oil | 32.00 |
| Cheese Filling | 20.00 |
| Acid Whey | 18.00 |
| Whey Protein Concentrate | 14.00 |
| Tapioca Maltodextrin | 6.00 |
| Polydextrose | 5.00 |
| Flour Salt | 2.00 |
| Lecithin (soy) | 1.50 |
| Yeast enhancer | 1.30 |
| Paprika | 0.70 |
| Total | 100.00 |

First, all of the soybean oil, lecithin, and paprika are blended to uniformity in the bowl of a Hobart mixer. The maltodextrin is placed in the bowl with oil/lecithin/paprika mix, and the combination is mixed to uniformity, on low speed, for several minutes. The polydextrose and remainder of the ingredients are subsequently added to the bowl and blended on high speed until achieving a density of 0.75 to 1.0 g/cm³. All mixing is done at room temperature. The bake stability is measured by microwaving a plastic spoonful, on medium setting, for 30 seconds. Little to no spread is observed, and the bake-stable filling does not overflow the spoon.

### Example 3

### Cheese Bake-Stable Filling

TABLE 3

| Component | Percent by weight |
|---|---|
| Soybean Oil | 32.00 |
| Cheese Filling | 20.00 |
| Acid Whey | 17.50 |
| Whey Protein Concentrate | 14.00 |
| Oat Fiber | 6.50 |
| Polydextrose | 5.00 |
| Flour Salt | 2.00 |
| Lecithin (soy) | 1.50 |
| Yeast enhancer | 0.80 |
| Flavors and Colors | 0.70 |
| Total | 100.00 |

First, all of the oil and half of mixture of the oat fiber and polydextrose are blended to uniformity, in the bowl of a Hobart mixer at low speed, for about four minutes. Then, the remainder of the oat fiber/polydextrose is added to the first blend, and blended on high, for ten minutes. The remainder of the ingredients are added to the second blend, and blended first on low, to incorporate (about two minutes) and then on high, for five minutes, to a density of about 1.5 g/cm³.

### Example 4

### Cheese Bake-Stable Filling

TABLE 4

| Component | Percent by weight |
|---|---|
| Clarified butter, melted | 32.00 |
| Cheese Powder | 20.00 |
| Acid Whey | 17.50 |
| Whey Protein Concentrate | 14.00 |
| Oat Fiber | 6.50 |
| Polydextrose | 5.00 |
| Flour Salt | 2.00 |
| Lecithin (soy) | 1.50 |
| Yeast enhancer | 0.80 |
| Flavors and Colors | 0.70 |
| Total | 100.00 |

First, all of the butter and half of the oat fiber are blended to uniformity, in a Hobart mixer at low speed, for about four minutes. Then, the remainder of the oat fiber is added to the first blend, and blended on high, for ten minutes. The remainder of the ingredients are added to the second blend, and blended first on low, to incorporate (about two minutes) and then on high, for five minutes, to a density of about 1.5 g/cm³.

### Example 5

### Cheese-Flavored Bake-Stable Filling

TABLE 5

| Component | Percent by weight |
|---|---|
| Safflower Oil | 32.00 |
| Cheese Filling | 20.00 |
| Acid Whey | 18.00 |
| Whey Protein Concentrate | 14.00 |
| Maltodextrin | 6.00 |
| Polydextrose | 5.00 |
| Salt | 2.00 |
| Yeast enhancer | 1.80 |
| Cheese Flavors and Colors | 1.30 |
| Total | 100.00 |

First, all of the maltodextrin and all of the polydextrose are comingled to approximate uniformity. Then, all of the safflower oil is placed in a commercial mixer, along with half of the maltodextrin/polydextrose. The oil and fibers are blended to uniformity at medium medium-low speed, for about five minutes. Then, the remainder of the fiber is added to the first blend, along with the remainder of the ingredients, and blended on high, for eight minutes, to a density of about 1.0 g/cm³.

### Example 6

### Cheese-Flavored Bake-Stable Filling

TABLE 6

| Component | Percent by weight |
|---|---|
| Soybean Oil | 32.00 |
| Nonfat Dry Milk Powder | 20.00 |
| Acid Whey | 17.50 |
| Whey Protein Concentrate | 14.00 |
| Oat Fiber | 11.50 |
| Powdered Sea Salt | 2.00 |
| Lecithin (soy) | 1.50 |
| Cheese Flavors and Colors | 1.50 |
| Total | 100.00 |

First, all of the soybean oil and 40.0 wt. % of the oat fiber is mixed in a paddle mixer to approximate uniformity at medium speed for ten minutes. Then, the remainder of the fiber is added to the first blend, along with the remainder of the ingredients, and blended on high, for fifteen minutes, to a density of about 0.8 g/cm³.

### Example 7

### Chocolate/Peanut-Flavor Bake-Stable Filling

TABLE 7

| Component | Percent by weight |
|---|---|
| Peanut Oil | 30.00 |
| Cocoa Powder | 22.00 |
| Peanut Powder | 10.50 |
| Cocoa butter powder | 20.00 |
| Oat Fiber | 7.50 |
| Polydextrose | 2.50 |
| Maltodextrin | 2.50 |
| Flour Salt | 2.00 |
| Lecithin (soy) | 1.50 |
| Chocolate-Peanut Flavors and Colors | 1.50 |
| Total | 100.00 |

First, all of the peanut oil and 60 wt. % of the oat fiber is mixed in a Vitamix commercial blender, heat turned off, to approximate uniformity at slow speed for fifteen minutes. Then, the remainder of the fiber is added to the first blend, along with the remainder of the ingredients and placed in the blender, and blended on high, for fifteen minutes, to a density of about 1.2 g/cm³.

### Example 8

### Fruit-Flavor Bake-Stable Filling

TABLE 8

| Component | Percent by weight |
|---|---|
| Coconut Oil | 40.00 |
| Fruit Powder | 30.00 |
| Oat Fiber | 24.00 |
| Maltodextrin | 6.50 |
| Salt | 1.00 |
| Fruit Flavors and Colors | 3.50 |
| Total | 100.00 |

First, all of the coconut oil and 25.0 wt. % of the oat fiber is mixed in a commercial horizontal mixer to approximate uniformity at medium speed for ten minutes. Then, the remainder of the fiber is added to the first blend and blended on high, for ten minutes. The remainder of the ingredients are added, at one minute intervals, with the endpoint being a density of less than 0.8 g/cm³.

### Example 9

### Onion Dip-Flavored Bake-Stable Filling

TABLE 9

| Component | Percent by weight |
|---|---|
| Soybean Oil | 30.00 |
| Milk Powder | 18.00 |
| Acid Whey | 18.00 |
| Whey Protein Concentrate | 10.00 |
| Oat Fiber | 10.00 |
| Polydextrose | 10.00 |
| Salt | 2.00 |
| Onion Dip Flavors and Colors | 1.30 |
| Total | 100.00 |

First, all of the soybean oil and 55.0 wt. % of the oat fiber is mixed in a commercial vertical mixer to approximate uniformity at low speed for five minutes. Then, the remainder of the fiber is added to the first blend and blended on high, for ten minutes. The remainder of the ingredients are added, and blended on medium-high to a density of about 1.0 g/cm³.

### Example 10

### Vanilla-Flavored Bake-Stable Filling

TABLE 10

| Component | Percent by weight |
|---|---|
| Soybean Oil | 30.00 |
| Milk Powder | 18.00 |
| Acid Whey | 18.00 |
| Whey Protein Concentrate | 10.00 |
| Oat Fiber | 10.00 |
| Polydextrose | 10.00 |
| Salt | 2.00 |
| Vanilla Flavors and Colors | 1.30 |
| Total | 100.00 |

First, all of the soybean oil and the oat fiber are mixed in a commercial mixer to approximate uniformity at low speed for three minutes. Then, the polydextrose and remainder of the ingredients are added to the first blend and blended on high, for ten minutes to a density of about 1.0 g/cm³.

### Example 11

### Crackers with Cheese-Flavored Bake-Stable Filling

The bake-stable filling from any of the Examples 1 through 6 is deposited in continuous manner on the surface of a sheeted cracker dough, with the top cracker sheet sandwiching the bake-stable filling between it and the bottom cracker sheet. The dough is cut into desired shape or shapes, and baked in continuous band oven at varying temperatures in about 5 to 7 zones. The temperature is 250° F. for several minutes, 300° F. for several minutes, then 450° F. temperature for one minute, then two stages of cooling. The bake-stable filling does not flow out of the cut ends, nor does it become brittle or unsightly. The finished product is crisp on the exterior and creamy on the interior, even after months held at room temperature under commercial conditions. The crackers are packaged as desired.

### Example 12

### Handheld Sweet Snack with Fruit-Flavored or Chocolate Peanut-Flavored Bake-Stable Filling

The bake-stable filling of Examples 7 or 8 or a combination thereof, are co-extruded with cookie dough so that the bake-stable filling is entirely enclosed within the dough. The extrusion of dough/bake-stable filling is cut at 0.5-1.5 inch intervals, and deposited onto baking sheets. The pieces are baked at 350° F. for as long as necessary to produce the desired baked qualities. The bake-stable filling does not flow out of the cut ends or cause the dough to become soggy, and remains creamy and lubricious for a reasonable shelf life.

### Example 14

### Chocolate-Flavored Sandwich Cookies with Vanilla Bake-Stable Filling

The bake-stable filling of Example 10 is deposited in a continuous manner on the surface of a slightly-sweetened, chocolate-flavored, sheeted cracker dough, with a top cracker sheet sandwiching the bake-stable filling between it and the bottom cracker sheet. The dough is cut into desired shape or shapes, and baked in continuous band oven at varying temperatures in about 5 to 7 zones. The temperature is 250° F. for several minutes, 300° F. for several minutes, then 450° F. temperature for one minute, then two stages of cooling. The bake-stable filling does not flow out of the cut ends, nor does it become brittle or unsightly. The finished product is crisp on the exterior and creamy on the interior, even after months held at room temperature under commercial conditions. The crackers are packaged as desired.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1. A bake-stable filling for food products comprising:
at least one fat ingredient and at least one fiber ingredient;
said bake-stable filling having an unbaked density;
said bake-stable filling having a baked density;
said baked density being less than about 1.875 grams per cubic centimeter (g/cm³);
said baked density being no greater than about 125 percent (%) of said unbaked density; and
said bake-stable filling having a baked water activity level of less than about 0.35.

2. A bake-stable filling as set forth in claim 1 wherein said baked density is less than about 1.25 g/cm³.

3. A bake-stable filling as set forth in claim 1 wherein said unbaked density is less than about 1.50 g/cm³.

4. A bake-stable filling as set forth in claim 1 having an unbaked water activity level greater than said baked water activity level.

5. A bake-stable filling as set forth in claim 1 wherein at least one of said fiber ingredients includes a particle size less than about 150 μm.

6. A bake-stable filling as set forth in claim 1 wherein at least one of said fiber ingredients includes a particle size of about 10 μm to about 100 μm.

7. A bake-stable filling as set forth in claim 1 wherein said fiber ingredients are present in a total amount of about 5.0 weight percent (wt. %) to about 20.0 wt. % based on the total weight of said bake-stable filling.

8. A bake-stable filling as set forth in claim 1 wherein said fiber ingredients are present in a total amount of about 10.0 wt. % to about 12.0 wt. % based on the total weight of said bake-stable filling.

9. A bake-stable filling as set forth in claim 1 wherein said fiber ingredients include at least one of oat fiber, polydextrose, grain fiber, indigestible dextrin, or a combination thereof.

10. A bake-stable tilling as set forth in claim 1 wherein said fat ingredients are present in a total amount of about 20.0 wt. % to about 40.0 wt. % based on the total weight of said bake-stable filling.

11. A bake-stable filling as set forth in claim 1 wherein said fat ingredients are present in a total amount of about 30.0 wt. % to about 33.0 wt. % based on the total weight of said bake-stable filling.

12. A bake-stable filling as set forth in claim 1 wherein said fat ingredients include at least one of soybean oil, cottonseed oil, canola oil, safflower oil, sunflower oil, coconut oil, palm oil, palm kernel oil, corn oil, or a combination thereof.

13. A bake-stable filling as set forth in claim 1 wherein each of said fat ingredients of said bake-stable filling substantially refrain from spreading upon passing microwave radiation through said bake-stable filling.

14. A bake-stable filling as set forth in claim 1 including optional ingredients present in a total amount of about 40.0 wt. % to about 75.0 wt. % based on the total weight of said bake-stable filling

15. A bake-stable filling as set forth in claim 14 wherein said optional ingredients include at least one of cheese; cheese powder; cheese filling; sour cream; milk; milk powder; soybeans; soybean powder; legumes; legume powder; nuts; nut powder; whey; whey powder; acid whey powder; whey protein concentrate powder; flour; salt; yeast enhancer; herbs, paprika, spices; flavorants; or a combination thereof.

16. A bake-stable filling as set forth in claim 14 wherein at least one of said optional ingredients includes a particle size of less than about 200 μm.

17. A bake-stable filling as set forth in claim 1 wherein said fat ingredients include soybean oil and said fiber ingredients include oat fiber.

18. A food product comprising:
a bake-stable filling;
a dough component;
said bake-stable filling being applied to said dough component;
said bake-stable filling including at least one fiber ingredient;
said bake-stable filling including at least one fat ingredient;
said bake-stable filling having an unbaked density;
said bake-stable filling having a baked density;
said baked density of said bake-stable filling being less than about 1.875 g/cm³;
said baked density being no greater than about 125% of said unbaked density; and
said bake-stable filling having a baked water activity level of less than about 0.35.

19. A process of forming a bake-stable filling for food products comprising the steps of:
mixing at least one fiber ingredient and at least one fat ingredient at a first speed to form a first blend;
mixing the first blend and at least one fiber ingredient at a second speed greater than the first speed to form a second blend; and
mixing the second blend until the second blend has a baked density of less than about 1.875 g/cm³ and a baked water activity level of less than about 0.35.

20. A process as set forth in claim 19 including mixing at least one optional ingredient into the second blend.
